(19) United States
(12) Patent Application Publication
(10) Pub. No.: US 2018/0211073 A1
(43) Pub. Date: Jul. 26, 2018

(54) COMBINED PASSIVE TAGS AND ACTIVE SHORT RANGE WIRELESS COMMUNICATIONS

(71) Applicants: Dennis Ching Chung Kwan, San Diego, CA (US); Suresh Kumar Singamsetty, Aliso Viejo, CA (US)

(72) Inventors: Dennis Ching Chung Kwan, San Diego, CA (US); Suresh Kumar Singamsetty, Aliso Viejo, CA (US)

(21) Appl. No.: 15/813,144

(22) Filed: Nov. 14, 2017

Related U.S. Application Data
(60) Provisional application No. 62/421,649, filed on Nov. 14, 2016.

(51) Int. Cl. G06K 7/10

(52) U.S. Cl. CPC G06K 7/10366; H04W 4/80

(57) ABSTRACT

An access control system that utilizes a combination of passive tags and active RFIDs. The system may combine passive and active circuitry in one package or may be separable. The system may incorporate legacy passive access control tags. An access control tag may be associated with a network protocol ID.

### CROSS-REFERENCE TO RELATED APPLICATIONS

This present disclosure claims the benefit of U.S. Provisional Application Ser. No. 62/421,649, filed on Nov. 14, 2016.

### BACKGROUND

Passive radio frequency identification devices (RFID) are in widespread use. They are a popular means of access control and security and a degree of location monitoring. However, the resolution possible with these devices alone is not as good as what can be obtained with active radio frequency devices. The drawback to most active radio frequency location and identification systems is the power requirements as well as the level of adoption. Active radio frequency devices often use more power and the current adoption rate is much lower for the more power efficient active radio frequency devices. There is a need for a system capable of bridging the gap to integrate existing RFID tracking and identification technology currently in-use with more precise low energy active radio frequency devices (such as Bluetooth Low Energy) and cloud-based identification.

### BRIEF SUMMARY

An access control system addressing these and other needs is herein disclosed. The system utilizes a combination of passive tags and active RFIDs, either combined in one package or separable.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a wireless communication device 100.

FIG. 2 illustrates an embodiment of a mesh network environment 200.

FIG. 3 illustrates an embodiment of a process for operating a wireless communication device 300.

FIG. 4 illustrates an embodiment of a wireless communication system 400.

FIG. 5 illustrates an embodiment of a system for integrating building automation with location awareness utilizing wireless mesh technology 500.

FIG. 6 illustrates an embodiment of a digital apparatus 600 to implement components and process steps of the system described herein.

### DETAILED DESCRIPTION

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in this context refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices.

“Software” in this context refers to logic implemented as processor-executable instructions in a machine memory (e.g. read/write volatile or nonvolatile memory or media).

“6LowPAN” in this context refers to an acronym of IPv6 (Internet Protocol Version 6) over Low power Wireless Personal Area Networks. It is a wireless standard for low-power radio communication applications that need wireless internet connectivity at lower data rates for devices with limited form factor. 6LoWPAN utilizes the RFC6282 standard for header compression and fragmentation. This protocol is used over a variety of networking media including Bluetooth Smart (2.4 GHz) or ZigBee or low-power RF (sub-1 GHz) and as such, the data rates and range may differ based on what networking media is used.

“Bluetooth Low-Energy (BLE)—or Bluetooth Smart” in this context refers to a wireless personal area network technology aimed at reduced power consumption and cost while maintaining a similar communication range as traditional Bluetooth. Like traditional Bluetooth, the frequency utilized is 2.4 GHz (ISM-Industrial, Scientific and Medical), the maximum range is generally 50-150 m with data rates up to 1 Mbps.

“Cellular” in this context refers to a communication network where the last link is wireless. The network is distributed over land areas called cells and utilizes one of the following standards GSM/GPRS/EDGE (2G), UMTS/HSPA (3G), LTE (4G). Frequencies are generally one of 900/1800/1900/2100 MHz. Ranges are 35 km max for GSM; 200 km max for HSPA and typical data download rates are: 35-170 kps (GPRS), 120-384 kbps (EDGE), 384 Kbps-2 Mbps (UMTS), 600 kbps-10 Mbps (HSPA), 3-10 Mbps (LTE).

“LoRaWAN” in this context refers to Low Power Wide Area Network, a media access control (MAC) protocol for wide area networks for low-cost, low-power, mobile, and secure bi-directional communication for large networks of up to millions of devices. LoRaWAN is employed on various frequencies, with a range of approximately 2-5 km (urban environment) to 15 km (suburban environment) and data rates of 0.3-50 kbps.

“NFC” in this context refers to “Near Field Communication” and is a subset of RFID (Radio Frequency Identifier) technology. NFC is standardized in ECMA-340 and ISO/IEC 18092. It employs electromagnetic induction between two loop antennae when NFC devices are within range (10 cm). NFC utilizes the frequency of 13.56 MHz (ISM). Data rates range from 106 to 424 kbit/s.

“SigFox” in this context refers to a cellular-style system that enables remote devices to connect using ultra-narrow band (UNB) technology and binary phase-shift keying (BPSK) to encode data. Utilizes the 900 MHz frequency and has a range of 30-50 km in rural environments and 3-10 km in urban environments with data rates from 10-1000 bps.

“Thread” in this context refers to a wireless mesh network standard that utilizes IEEE802.15.4 for the MAC (Media Access Control) and Physical layers, IETF IPv6 and 6LoWPAN (IVP6). Thread operates at 250 kbps in the 2.4 GHz band. The IEEE 802.15.4-2006 version of the specification is used for the Thread stack.

“Weightless” in this context refers to an open machine to machine protocol which spans the physical and mac layers. Operating frequency: 200 MHz to 1 GHz (900 MHz (ISM) 470-790 MHz (White Space)) Fractional bandwidth of spectrum band: <8% (for continuous tuning). Range up to 10 km and data Rates which range from a few bps up to 100 kbps

“WiFi” in this context refers to a wireless network standard based on 802.11 family which consists of a series of half-duplex over-the-air modulation techniques that use the same basic protocol. Frequencies utilized include 2.4 GHz and 5 GHz bands with a range of approximately 50 m. Data rate of 600 Mbps maximum, but 150-200 Mbps is more typical, depending on channel frequency used and number of antennas (latest 802.11-ac standard should offer 500 Mbps to 1 Gbps).

“Z-Wave” in this context refers to a wireless standard for reliable, low-latency transmission of small data packets. The Z-Wave utilizes the Z-Wave Alliance ZAD12837/ITU-T G.9959 standards and operated over the 900 MHz frequency in the US (Part 15 unlicensed ISM) and is modulated by Manchester channel encoding. Z-Wave has a range of 30 m and data rates up to 100 kbit/s.

“ZigBee” in this context refers to a wireless networking standard for low power, low data rate, and lost cost applications. The Zigbee protocol builds upon the Institute of Electrical and Electronics Engineers (IEEE) 802.15.4 standard which defines a short range, low power, low data rate wireless interface for small devices that have constrained power, CPU, and memory resources. Zigbee operates over the 2.4 GHz frequency, with a range of 10-100 m and data rates of 250 kbps.

Embodiments of wireless communication devices are disclosed herein, and may by example utilize particular wireless technologies and/or protocols. Other embodiments within the scope of invention may utilize different wireless technologies, for example those defined above.

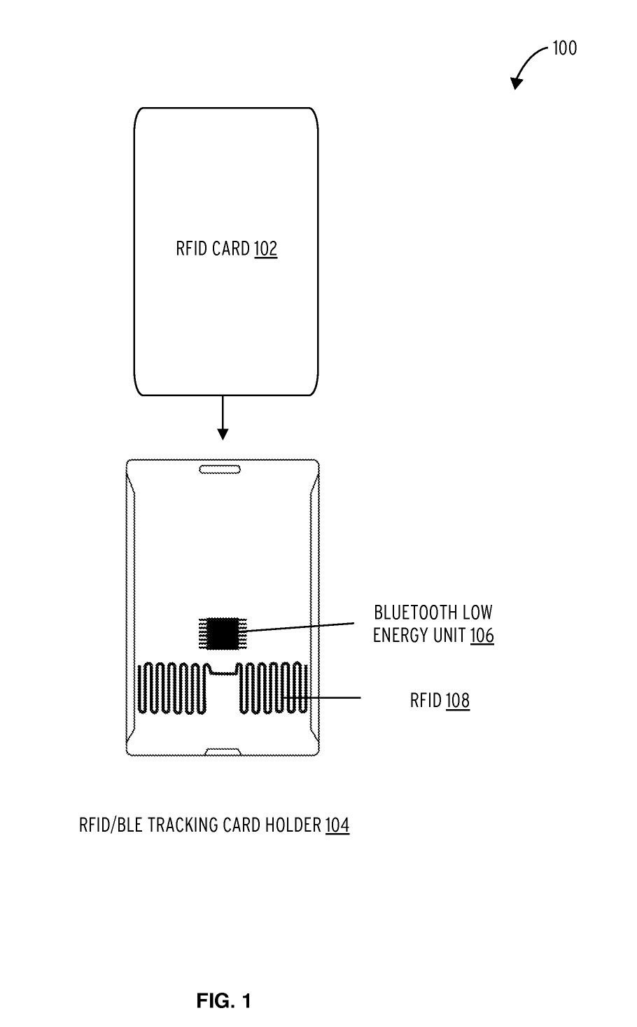

FIG. 1 illustrates an embodiment of a wireless communication device 100. The wireless communication device 100 comprises an RFID Card 102, and an RFID/BLE tracking card holder 104. The RFID/BLE tracking card holder 104 further comprises a Bluetooth low energy unit 106, and an RFID 108. This device allows for the use and integration of legacy passive RF systems with building tracking and location systems.

The RFID/BLE tracking card holder 104 has a slot to hold an existing RFID Card 102 which may be an identification card. Current class 1 first and second generation RFID tags hold more data and both can be easily cloned. The range for certain passive RFID tags is 1-3 meters, this combined with BLE proximity detection and the cloud, provides a second level of authentication (which can not be easily spoofed the way RFID can) through position tracking and also allows for more precise location tracking.

RFID tags can be made extremely thin, so one of the main restrictions on thickness is the battery, then the thickness of the Bluetooth circuitry. Other dimensions may be restricted by RFID antennae dimensions depending on the frequency used.

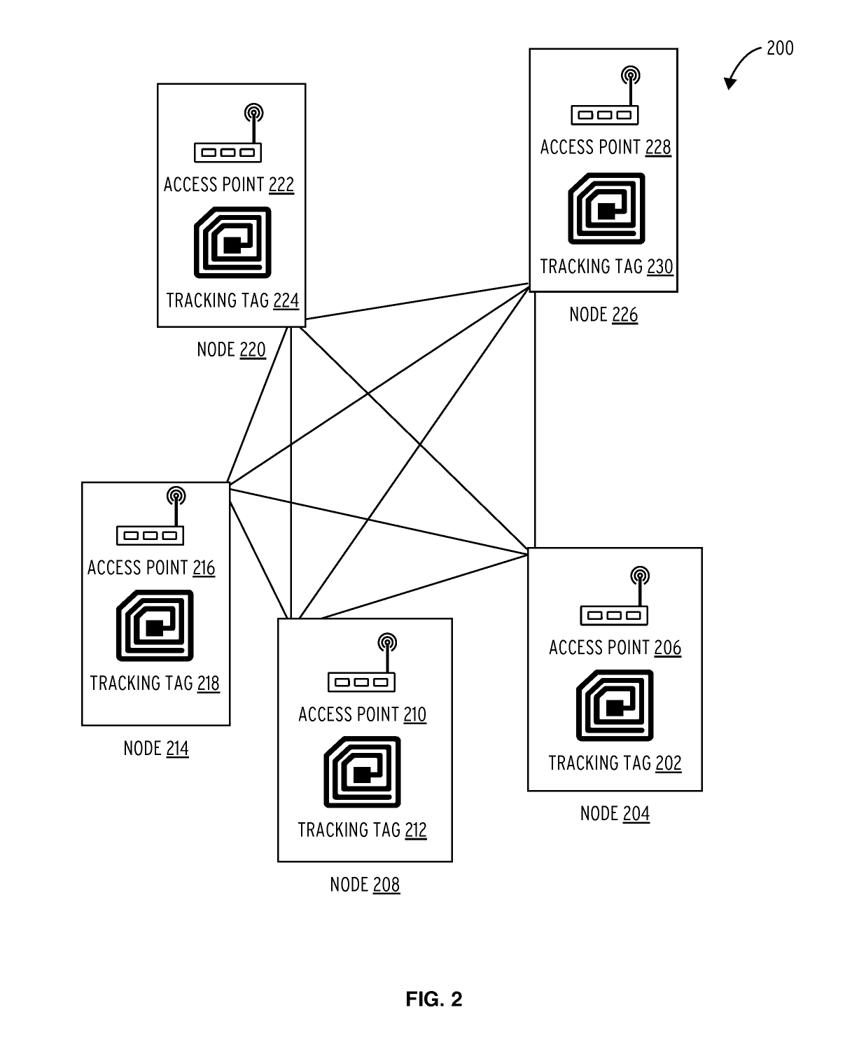

FIG. 2 illustrates an embodiment of a mesh network environment 200. The environment 200 comprises the node 220, the node 226, the node 204, the node 214, the node 208, and an RFID BLE tracking card holder 502.

The node 220 comprises the tracking tag 224, and the access point 222. The node 226 comprises the access point 228 and the tracking tag 230. The node 204 comprises the tracking tag 202 and the access point 206. The node 208 comprises the access point 210 and the tracking tag 212. The node 214 comprises the access point 216 and the tracking tag 218.

The RFID Card 102 and RFID/BLE tracking card holder 104 may be utilized in the environment 200, e.g., as tracking tags.

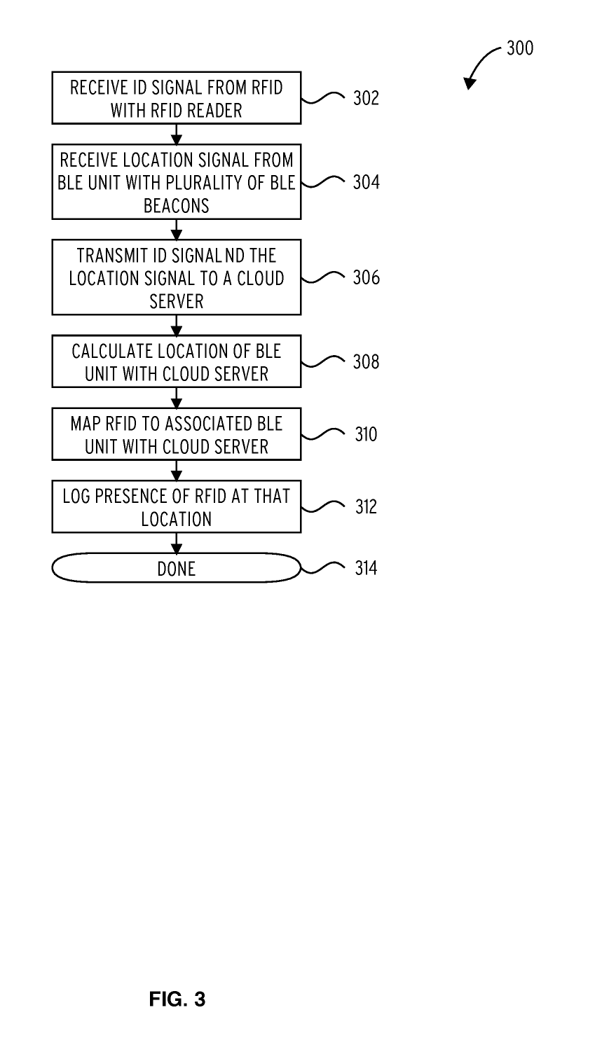

FIG. 3 illustrates an embodiment of a process for operating a wireless communication device 300.

In block 302, process for operating a wireless communication device 300 receives an ID signal from an RFID with an RFID reader. In block 304, process for operating a wireless communication device 300 receives a location signal from a BLE unit with a plurality of BLE beacons. In block 306, process for operating a wireless communication device 300 transmits the ID signal and the location signal to a cloud server. In block 308, process for operating a wireless communication device 300 calculates the location of the BLE unit with the cloud server. In block 310, process for operating a wireless communication device 300 maps the RFID to the associated BLE unit with the cloud server. In block 312, process for operating a wireless communication device 300 logs the presence of the RFID at that location. In done block 314, process for operating a wireless communication device 300 ends.

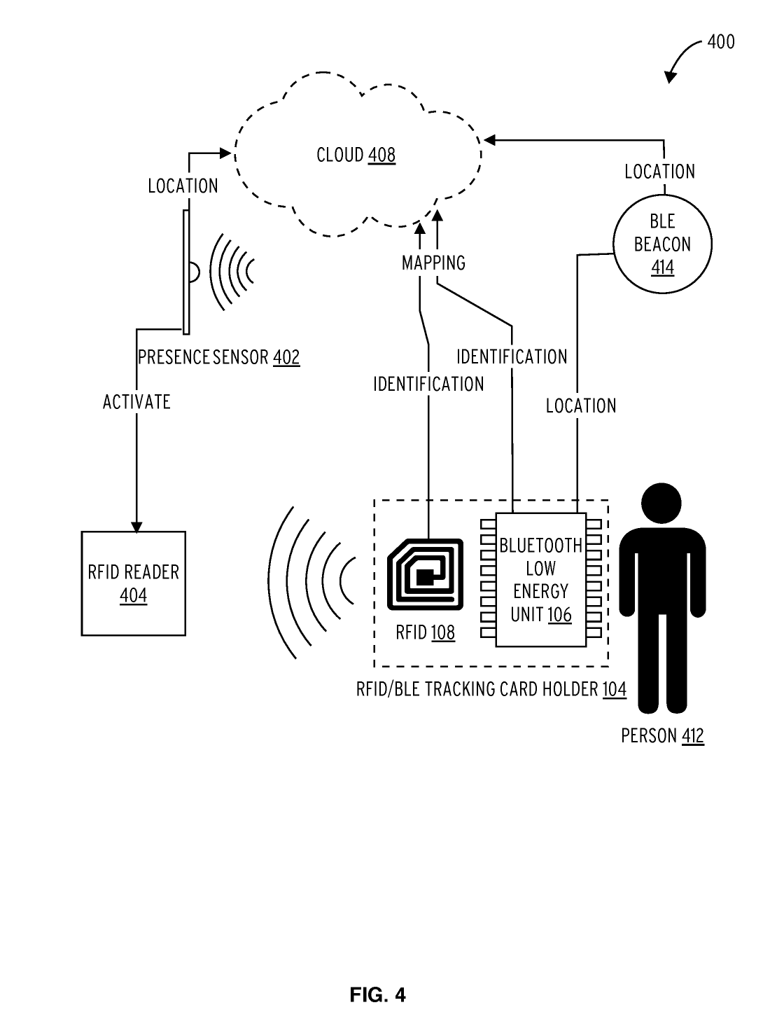

FIG. 4 illustrates an embodiment of a wireless communication system 400. The wireless communication system 400 comprises an RFID/BLE tracking card holder 104, a presence sensor 402, an RFID reader 404, a cloud network 408, a person 412, and a BLE beacon 414.

The RFID/BLE tracking card holder 104 further comprises the Bluetooth low energy unit 106, and the RFID 108. The person 412 is carrying the RFID/BLE tracking card holder 104, and activates a presence sensor 402, the presence sensor 402 then activates the RFID reader 404. The RFID reader 404 emits an electromagnetic field which induces a current within the RFID 108, activating it and logging the presence of that RFID at that location. The Bluetooth low energy unit 106 within the RFID/BLE tracking card holder 104 has its position tracked by the BLE beacon 414 the identification of the person 412 is mapped to the identification of the RFID 108 and the Bluetooth low energy unit 106 within the cloud network 408 and the location of the person 412 may be logged.

This allows a greater degree of location accuracy than an RFID would provide alone, allowing the system to track that a person has entered an area and also where the person is within that area. In addition, the system may check to ensure that the location determined by the Bluetooth low energy unit 106 properly correlates with the general location of the RFID 108. This provides an extra degree of security, because the system can generate an alert if an RFID 108 checks into an area but the Bluetooth low energy unit 106 which is associated with that RFID 108 is not in the same area.

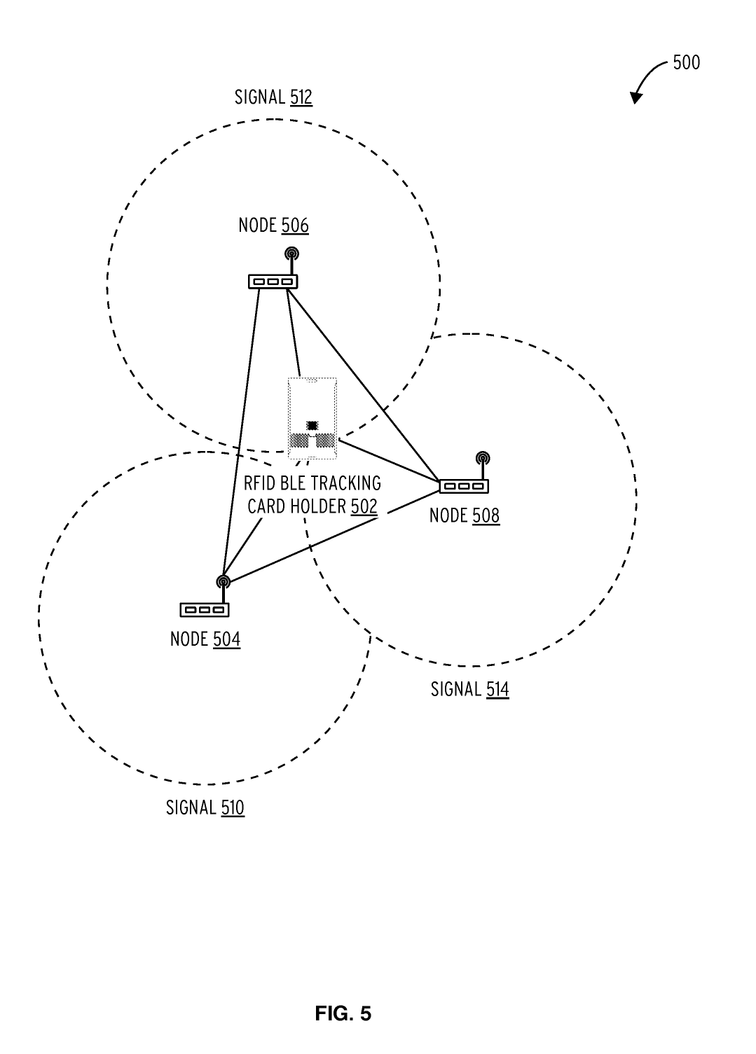

FIG. 5 illustrates an embodiment of a system for integrating building automation with location awareness utilizing wireless mesh technology 500.

The system for integrating building automation with location awareness utilizing wireless mesh technology 500 comprises a node 506, a node 508, a node 504, a signal 512, a signal 514, the signal 510, and an RFID BLE tracking card holder 502.

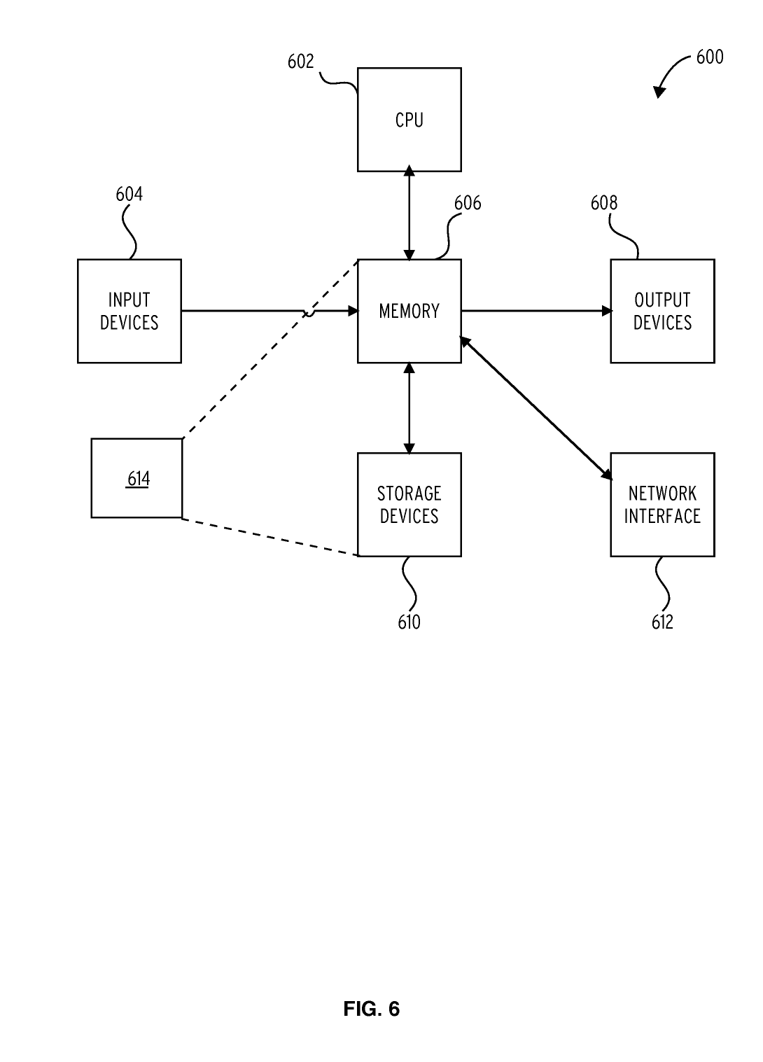

FIG. 6 illustrates an embodiment of a digital apparatus 600 to implement components and process steps of the system described herein.

Input devices 604 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 604 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 604 are provided via various machine signal conductors (e.g., busses or network interfaces) and circuits to memory 606.

The memory 606 is typically what is known as a first or second level memory device, providing for storage (via configuration of matter or states of matter) of signals received from the input devices 604, instructions and information for controlling operation of the CPU 602, and signals from storage devices 610.

The memory 606 and/or the storage devices 610 may store computer-executable instructions and thus forming logic 614 that when applied to and executed by the CPU 602 implement embodiments of the processes disclosed herein.

Information stored in the memory 606 is typically directly accessible to the CPU 602 of the device. Signals input to the device cause the reconfiguration of the internal material/energy state of the memory 606, creating in essence a new machine configuration, influencing the behavior of the digital apparatus 600 by affecting the behavior of the CPU 602 with control signals (instructions) and data provided in conjunction with the control signals.

Second or third level storage devices 610 may provide a slower but higher capacity machine memory capability. Examples of storage devices 610 are hard disks, optical disks, large capacity flash memories or other non-volatile memory technologies, and magnetic memories.

The CPU 602 may cause the configuration of the memory 606 to be altered by signals in storage devices 610. In other words, the CPU 602 may cause data and instructions to be read from storage devices 610 in the memory 606 from which may then influence the operations of CPU 602 as instructions and data signals, and from which it may also be provided to the output devices 608. The CPU 602 may alter the content of the memory 606 by signaling to a machine interface of memory 606 to alter the internal configuration, and then converted signals to the storage devices 610 to alter its material internal configuration. In other words, data and instructions may be backed up from memory 606, which is often volatile, to storage devices 610, which are often non-volatile.

Output devices 608 are transducers which convert signals received from the memory 606 into physical phenomenon such as vibrations in the air, or patterns of light on a machine display, or vibrations (i.e., haptic devices) or patterns of ink or other materials (i.e., printers and 3-D printers).

The network interface 612 receives signals from the memory 606 and converts them into electrical, optical, or wireless signals to other machines, typically via a machine network. The network interface 612 also receives signals from the machine network and converts them into electrical, optical, or wireless signals to the memory 606.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

What is claimed:

1. An access control system that utilizes a combination of passive tags and active RFIDs.
